(19) United States
(12) Patent Application Publication
(10) Pub. No.: US 2024/0424546 A1
(43) Pub. Date: Dec. 26, 2024

(54) Method for Forming a Sheet Metal Component in a Press Apparatus, and Press Apparatus

(71) Applicant: Bayerische Motoren Werke Aktiengesellschaft, Muenchen (DE)

(72) Inventors: Bernhard GLUECK, Fuerstenfeldbruck (DE); Ulrich SCHMID, Muenchen (DE)

(21) Appl. No.: 18/698,243

(22) PCT Filed: Sep. 27, 2022
(86) PCT No.: PCT/EP2022/076777

§ 371 Date: Apr. 3, 2024

(30) Foreign Application Priority Data
Oct. 4, 2021 (DE) 10 2021 125 661.5

(51) Int. Cl. B21D 22/02

(52) U.S. Cl. CPC B21D 22/02

(57) ABSTRACT

A method for forming a sheet-metal component in a press apparatus includes providing a sheet-metal blank as a base material for the sheet-metal component and sensing at least one characterizing parameter of the sheet-metal blank by a sensing device of the press apparatus before a forming process for the sheet-metal component takes place. The at least one characterizing parameter is transmitted to an electronic computing device of the press apparatus. The sheet-metal component is formed from the sheet-metal blank taking into account the at least one characterizing parameter.

### BACKGROUND AND SUMMARY

The invention relates to a method for forming a sheet-metal component in a press apparatus. The invention also relates to a computer program product, a computer-readable storage medium, and a press apparatus.

The prior art has already disclosed pressing plants designed to create components, for example for motor vehicles. In this case, the appropriate component is pressed from what are known as sheet-metal blanks that originate from sheet-metal rolls, for example. In this case, the sheet-metal blanks are flat metallic structures which for example can be stamped within the press apparatus and can thus be brought into shape. In this context, pressing plants are known which receive the corresponding unrolled sheet-metal blanks or already pre-manufactured sheet-metal blanks.

Especially in the case of the already pre-manufactured and for example supplied sheet-metal blanks there is no detailed knowledge according to plan about corresponding material properties and process parameters within the scope of the production process for these sheet-metal blanks. In this context, only global material test certificates are available for the metal roll, which is also referred to as a coil. For example, the provided or manufactured sheet-metal blanks are then stored for intervals of up to six months for further use, which is why possibly sensed properties of the material may change there.

DE 10 2019 110 619 A1 relates to a method for tracking a component in a production line comprising a plurality of process systems, in which by means of respective process systems of the production line, the component is processed and/or tested and a respective processing signal characterizing the processing and/or testing is provided for a superordinate electronic computing device, the component is tracked through the production line along the plurality of process systems by means of the computing device on the basis of the received processing signals, wherein a request signal, which characterizes a component property, from one of the process systems of the production line is received by means of the computing device, and the component processed and/or tested in the process system is determined and at least one component information signal characterizing the component property of the determined component is provided for the process system by means of the computing device.

It is an object of the present invention to develop a method, a computer program product, a computer-readable storage medium, and a press apparatus, by means of which a sheet-metal component can be manufactured or formed better.

One aspect of the invention relates to a method for forming a sheet-metal component in a press apparatus. There is the provision of a sheet-metal blank as base material for the sheet-metal component. At least one parameter currently characterizing the sheet-metal blank is sensed using a sensing device of the press apparatus before a forming process for the sheet-metal component takes place. There is the transmission of the sensed characterizing parameter to an electronic computing device of the press apparatus and a forming of the sheet-metal component from the sheet-metal blank taking into account the characterizing parameter.

In particular, this thus renders possible the use of already pre-manufactured sheet-metal blanks in order to be able to reliably create the sheet-metal component. In particular, the characterizing parameter is sensed before the forming process, whereby current properties of the sheet-metal component can be considered.

In particular, the press apparatus is a single process system in a production line. In other words, a production line may include a multiplicity of further process systems, which for example can cut the appropriate sheet-metal blanks to size from a sheet-metal roll, which is known as a coil. In other words, the pre-manufactured sheet-metal blanks are sensed accordingly within a single process system, specifically within the press apparatus, and the forming process can then be adapted within the press apparatus on the basis of the characterizing parameter sensed within the press apparatus. Thus, in particular, process systems for creating the sheet-metal blank and for storing the sheet-metal blank are not part of the present press apparatus.

In other words, provision is made for the material properties of the sheet-metal blanks provided to be able to be sensed inline and accurately for each part within the press apparatus and for the material properties to be able to be stored accordingly. As a result, at least the material characteristic values are available for each individual sheet-metal blank before the shaping process and, for example, the deformation process can be adapted or controlled in a targeted manner. In particular, this is advantageous in that sensing can be implemented directly within the press apparatus, and so the current state is sensed at the time of deformation, and hence changes of measurement values over time, for example as a result of the evaporation of applied oil, oil displacement due to crowning and stacking of the blanks, or further changes can be excluded.

As an alternative to inline sensing, the method can also be implemented for a sensing device separate from the press apparatus. For example, a separate sensing device can be used following the creation of the sheet-metal blank, and the sensed sheet-metal blanks can only subsequently be transferred to the press apparatus which is separate from the sensing device. In particular, the sensing device thus is formed separately from the press apparatus and from the creation apparatus for creating the sheet-metal blanks.

Further, quality control for the created component, for example, can also be implemented, preferably within the press apparatus and preferably at the end of the deformation process. An inspection with regards to cracks and/or the geometry can be realized in this context. A process parameter can likewise be adapted accordingly on the basis of this quality control.

According to an advantageous embodiment, a process parameter of the forming process is adapted on the basis of the characterizing parameter for the sheet-metal blank. For example, standard values for the forming process can be adapted in accordance with the characterizing parameter, such that the corresponding forming process can be realized individually for the sheet-metal blank. Hence, it is possible to provide an improved sheet-metal component, whereby subsequent process steps can be simplified.

It was also found to be advantageous if a reoiling is adapted as the process parameter depending on the characterizing parameter for the sheet-metal blank. In particular, the sheet-metal blank is already pre-oiled, for example already on the coil. For example, this serves to be able to simplify process steps during the unrolling of the coil and the deformation of the coil and for example to prevent corrosion on the sheet-metal blank. However, changes in the oil layer may arise, for example due to the storage of the already produced sheet-metal blanks, and so a corresponding reoiling must be implemented before the actual forming process. In particular, this can be carried out accurately for each part on the basis of a reoiling system within the press apparatus, whereby the spray pattern on the respective sheet-metal blank may be modified, with the result that, on the basis of the measurement of the degree of oiling of the blank, a target oiling state can always be obtained directly in the run-up to the forming process.

It is also advantageous if a thickness of the sheet-metal blank and/or an oiling of the sheet-metal blank and/or a material property of the sheet-metal blank is sensed as the characterizing parameter by means of the sensing device before the forming process. For example, a distance sensor, a camera, a magnet sensor, or a laser sensor can be used as sensing device to sense the thickness of the sheet-metal blank and/or an oiling of the sheet-metal blank and/or a material property of the sheet-metal blank as the characterizing parameter. Thus, unchanging parameters can also be sensed at the same time. For example, material properties can be mechanical properties such as tensile strength and yield strength, and/or surface roughnesses such as roughness value and peak number, and/or a zinc layer thickness. Thus, it is possible to sense different characterizing parameters for the sheet-metal blank, with the result that, subsequently during the forming process, an appropriate adaptation can be implemented within the forming process.

In a further advantageous embodiment, the sheet-metal blank or the sheet-metal component is labeled by means of a labeling device of the press apparatus. For example, the sheet-metal blank can be labeled by means of a serial number. The latter can then be stored accordingly and for example combined with the characterizing parameter such that a serialization of the sheet-metal blank can be realized. Hence, the characterizing parameter can be tracked accurately for each part on the basis of the serial number. Further, the corresponding properties of the sheet-metal blank or already created sheet-metal component can also be considered in subsequent process steps, with the result that subsequent process steps can also be adapted. The serial number should be considered purely by way of example; further types of labels, for example barcodes, are also possible.

Further, it was found to be advantageous if the sheet-metal blank or the sheet-metal component is labeled by means of a labeling device in the form of a laser device and/or by means of a labeling device in the form of a stamping device. It is particularly advantageous to introduce the label within the component or sheet-metal component in a manner invisible to the human eye, with the result that for example the label is not visible to the human eye in subsequent process steps and/or on the painted finished part. It is self-evident to a person skilled in the art that further labeling methods may also be used to label the sheet-metal blank or sheet-metal component, for example impressing a code at one of the presses within the production line of the press apparatus. Traceability which is accurate for each part is provided as a result of the serialization, even in the case of provided blanks, especially in the case of what are known as purchased blanks.

According to a further advantageous embodiment, the characterizing parameter and a serial number of the sheet-metal blank or sheet-metal component are stored together by means of the electronic computing device. This makes it possible to be able to appropriately store the characterizing parameter and the serial number, with the result that traceability of the characterizing parameter and the sheet-metal blank can also be realized in subsequent process steps. In particular, this simplifies subsequent process steps and can contribute to increasing the quality.

Further, it is advantageous if the electronic computing device adapts a process parameter of the forming process to the characterizing parameters of the sheet-metal blank and/or a process parameter of the forming process is received and processed further at least in part by a superordinate computing device.

A further aspect of the invention relates to a press apparatus for forming a sheet-metal component, having at least a sensing device and an electronic computing device, wherein the press apparatus is designed to carry out a method according to the preceding aspect.

In particular, the method is carried out by means of the press apparatus.

Advantageous embodiments of the method should be considered to be advantageous embodiments of the press apparatus. To this end, the press apparatus has physical features which allow the method or an advantageous embodiment thereof to be carried out.

Further features of the invention emerge from the claims, the figures and the description of the figures. The features and feature combinations mentioned above in the description and the features and feature combinations mentioned below in the description of the figures and/or shown only in the figures are usable not only in the respectively specified combination but also in other combinations or on their own.

The invention is now explained in more detail on the basis of a preferred exemplary embodiment and with reference to the drawings.

### BRIEF DESCRIPTION OF THE DRAWINGS

FIG. 1 shows a schematic flowchart according to an embodiment of the method; and

FIG. 2 shows a schematic side view according to an embodiment of a press apparatus.

### DETAILED DESCRIPTION OF THE DRAWINGS

In the figures, the same or functionally equivalent elements have been provided with the same reference signs.

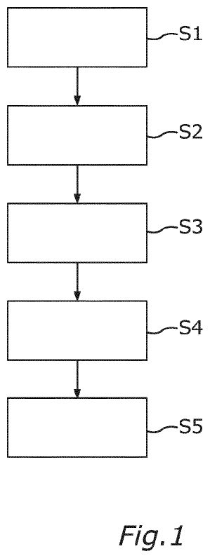

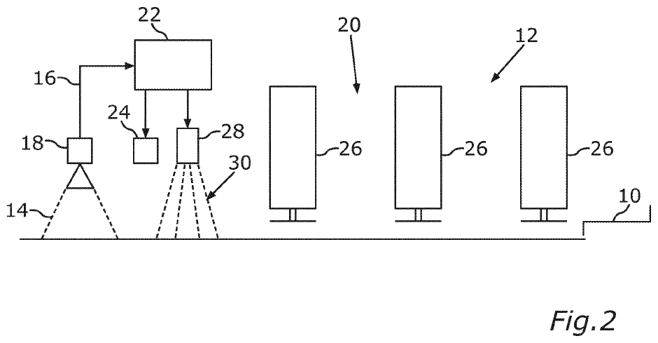

FIG. 1 shows a schematic flowchart according to an embodiment of the method. In particular, FIG. 1 shows a method for forming a sheet-metal component 10 (FIG. 2) in a press apparatus 12 (FIG. 2). A sheet-metal blank 14 (FIG. 2) is provided as base material for the sheet-metal component 10 in a first step S1. At least one parameter 16 (FIG. 2) currently characterizing the sheet-metal blank 14 is sensed in a second step S2 by means of a sensing device 18 (FIG. 2) of the press apparatus 12 before a forming process 20 (FIG. 2) for the sheet-metal component 10 takes place. Then, in a third step S3 there is the transmission of the sensed characterizing parameter 16 to an electronic computing device 22 (FIG. 2) of the press apparatus 12 and/or to a separate computing device, for example algorithms for machine learning on a local “edge computer” and/or in the decentralized computer center or in the cloud.

In an additional alternative fourth step S4, the sheet-metal blank 14 or the sheet-metal component 10 can be labeled by means of a labeling device 24 (FIG. 2) of the press apparatus 12. In the present case, the sheet-metal blank 14 is labeled. For example, this can be carried out by means of a labeling device 24 in the form of a laser device and/or by means of a labeling device 24 in the form of a stamping device. In particular, the labeling can be carried out on the basis of a serial number, for example. Then, provision can be made for the characterizing parameter 16 and the serial number of the sheet-metal blank 14 or sheet-metal component 10 to be stored together by means of the electronic computing device 22. Consequently, the labeling can be carried out before the forming process 20 and/or during the forming process 20 and/or after the forming process 20.

Then, in a fifth step S5, there is in turn the forming of the sheet-metal component 10 from the sheet-metal blank 14 taking into account the characterizing parameter 16.

FIG. 2 shows a schematic side view according to an embodiment of a press apparatus 12. In the present case, the forming process 20 in particular takes place in a corresponding forming device or in presses 26, for example. In particular, the sheet-metal blank 14 or at least one parameter characterizing the sheet-metal blank is sensed first by means of the sensing device 18, as seen from the left in FIG. 2. Then, the characterizing parameter 16 is transmitted to the electronic computing device 22. Subsequently, the sheet-metal blank 14 is labeled by means of the labeling device 24 in accordance with the exemplary embodiment shown in FIG. 2. Provision can then be made for a process parameter of the press line to be adapted, in particular on the basis of the sensed characterizing parameter 16 for the sheet-metal blank 14. For example, the process parameter of the forming press or, by way of a reoiling system 28 of the press apparatus 12, a reoiling 30 can be adapted as the process parameter on the basis of the characterizing parameter 16.

In particular, by means of the sensing device 18 for example, a thickness of the sheet-metal blank 14 and/or an oiling of the sheet-metal blank 14 and/or a material property of the sheet-metal blank 14 can be sensed as the characterizing parameter 16 before the forming process 20. For example, material properties may relate to mechanical properties such as tensile strength and yield strength, and/or surface roughnesses such as roughness value and peak number, and/or a zinc layer thickness.

In particular, provision is therefore made for the material properties of the sheet-metal blank 14 to be sensed accurately for each part, inline at the press apparatus 12, and for each sheet-metal blank 14 then for example to be provided with a serial number or manufacturer's serial number. As a result, at least the material characteristics are available before the forming process 20 for each individual sheet-metal blank 14 and the forming process 20 can be adapted or controlled in a targeted manner. For example, the reoiling system 28 can modify the spray pattern accurately for each part with the result that, on the basis of the measurement of the degree of oiling of the sheet-metal blank 14, the target oiling state is always obtained directly in the run-up to the forming process. A serialization of the sheet-metal blanks 14 or individual parts can likewise be implemented by means of laser marking for example or else by means of other methods, for example impressing a code at one of the presses 26. As a result of serialization, accurate tracking for each part is also possible in the case of provided sheet-metal blanks 14, so-called purchased blanks.

The advantage of sensing directly within the press apparatus 12 lies in the fact that the current state at the time of pressing out is sensed, and hence it is possible to exclude changes in the measurement values over time, for example due to evaporation of the oil, oil displacement due to crowning and stacking of the sheet-metal blanks 14, or the like, and the method can also be used inter alia for what are known as purchased blanks.

### LIST OF REFERENCE CHARACTERS

10 Sheet-metal component
12 Press apparatus
14 Sheet-metal blank
16 Characterizing parameter
18 Sensing device
20 Forming process
22 Electronic computing device
24 Labeling device
26 Presses
28 Reoiling system
30 Reoiling
S1 First step
S2 Second step
S3 Third step
S4 Fourth step
S5 Fifth step

1.-9. (canceled)

10. A method for forming a sheet-metal component in a press apparatus, comprising the steps of:
providing a sheet-metal blank as a base material for the sheet-metal component;
sensing at least one characterizing parameter of the sheet-metal blank by a sensing device of the press apparatus before a forming process for the sheet-metal component takes place;
transmitting the at least one characterizing parameter to an electronic computing device of the press apparatus; and
forming the sheet-metal component from the sheet-metal blank taking into account the at least one characterizing parameter.

11. The method according to claim 10, wherein a process parameter of the forming process is adapted on a basis of the at least one characterizing parameter.

12. The method according to claim 11, wherein the process parameter is a reoiling.

13. The method according to claim 10, wherein the at least one characterizing parameter is a thickness of the sheet-metal blank and/or an oiling of the sheet-metal blank and/or a material property of the sheet-metal blank.

14. The method according to claim 10, further comprising the step of labeling the sheet-metal blank or the sheet-metal component by a labeling device of the press apparatus.

15. The method according to claim 14, wherein the labeling device is a laser device and/or a stamping device.

16. The method according to claim 10, further comprising the step of storing together the at least one characterizing parameter and a serial number of the sheet-metal blank or the sheet-metal component by the electronic computing device.

17. The method according to claim 10, wherein the electronic computing device adapts a process parameter of the forming process to the at least one characterizing parameter and/or wherein the process parameter of the forming process is received and processed further at least in part by a superordinate computing device.

18. A press apparatus for forming a sheet-metal component, comprising:
a sensing device; and
an electronic computing device;
wherein the press apparatus is configured to perform the method according to claim 10.
